(19) United States
(12) Patent Application Publication
(10) Pub. No.: US 2021/0309496 A1
(43) Pub. Date: Oct. 7, 2021

(54) SELF-POWERED CLAM BUCKET ASSEMBLY

(71) Applicant: Anders RAGNARSSON, Chester, NH (US)

(72) Inventor: Anders RAGNARSSON, Chester, NH (US)

(21) Appl. No.: 16/839,918

(22) Filed: Apr. 3, 2020

(51) Int. Cl. B66C 3/02; E02F 3/40; E02F 3/36; B66C 3/14

(52) U.S. Cl. CPC B66C 3/02; B66C 3/14; E02F 3/3663; E02F 3/404

(57) ABSTRACT

A clam bucket assembly comprise an assembly framework which comprises an upper section and a lower section. First and second clam buckets are supported by the lower section of the assembly framework, a first bucket cylinder controls operation of the first clam bucket to engage and discharge a desired bulk material, and a second bucket cylinder controls operation of the second clam bucket to engage and discharge a desired bulk material. The clam bucket assembly supports its own independent power module for supplying hydraulic power to at least the first and the second bucket cylinders and controlling operation of the first and the second clam buckets. The power module is supported by the upper section of the assembly framework, and the clam bucket assembly is completely powered solely by the power module and controlled by radio remote control receiver and transmitter.

### FIELD OF THE INVENTION

The present invention relates to a clam bucket assembly which is self-powered so that when the self-powered clam bucket assembly is suspended from a crane, or some other (hydraulically) actuated arm, the clam bucket assembly can grab and pick up a desired bulk material, such as dirt, sand, ground, rocks, stones, debris, mud, grain, recycle material, etc., and, thereafter, be moved to another location so that the grabbed portion of bulk material can be easily and readily deposited onto a pile of bulk material, into a container, onto a transport vehicle, etc. The clam bucket assembly includes a pivotable the internal power module, which maintains the power module in a substantially vertical orientation during use as well as during transportation of the self-powered clam bucket assembly to a desired location.

### BACKGROUND OF THE INVENTION

Clam buckets are well known in the art and are utilized for a variety of different excavation applications. Such clam buckets may be, for example, supported by a wire cable of a mechanical arm or boom of a heavy equipment base, or some other similar heavy duty vehicle, a crane, an excavator, a tractor, a truck, etc. However, with respect to all such known prior clam buckets devices, the operating power is typically supplied by a power source that is mounted at the base of the equipment a considerable distance away from the clam buckets but interconnected therewith via a plurality of hydraulic lines. That is, typically hydraulic power is delivered to the remote clam buckets via hydraulic lines that extend from a hydraulic pump, which is mounted on and driven by the engine or motor of the heavy equipment, to the remotely located clam buckets to control operation thereof.

In addition, many of the known prior art clam bucket devices are somewhat difficult for an operator to maneuver due to lack of visibility of the grappler device.

Clam buckets which are operated by means of drag lines and derricks of varying description are well known in the prior art and have for years been used for such purposes as moving logs, excavation of channels, digging holes for foundations in the construction of buildings and dredging canals. These buckets are provided with hinged mandibles which are controlled by cables extending from the bucket through a system of sheaves in the derrick or crane apparatus and wound on drums which cooperate with the engine of the machine. An operator controls the operation of the crane boom and drums to effect the desired work using the clam shell to scoop and transport several yards of earth in each digging and lifting sequence.

In some instances it is desirable to dig a trench or excavation without traversing the axis of the trench with the machine accomplishing the excavation. This is sometimes necessary due to the close proximity of the trench to an existing structure or forms, or in certain circumstances where it is simply more desirable to have the trenching or excavating equipment in nonalignment with the trench or area to be excavated itself. Under these circumstances it is very difficult to use conventional excavators and trenching devices because such machines most often depend upon alignment with the traverse of the trench to accomplish the intended purpose. In most instances, excavators and ditching machines must be aligned with a trench to be constructed in order to dig the trench.

### SUMMARY OF THE INVENTION

Wherefore, it is an object of the present invention to overcome the above mentioned shortcomings and drawbacks associated with the prior art.

A further object of the present invention is to provide the clam bucket assembly with its own internal source of hydraulic operating power so that all of the hydraulic requirements, for powering the associated components of the clam bucket assembly, are supplied directly by a hydraulic power source that is completely incorporated and integrated into the clam bucket assembly. In other words, the clam bucket assembly, according to the present disclosure, is completely self powered and can operate without connecting to any source of power that is located remote from the clam bucket assembly. None of the operating power for the clam bucket assembly is delivered from a source externally of the clam bucket assembly.

Yet a further object of the present invention is to equip the clam bucket assembly with a radio remote control receiver which communicates wirelessly, via radio signals, with a radio control transmitter typically located within an operator cabin at the base of a crane. The operator is thus able to send desired commands, e.g., separate the pair of clam buckets from one another, to move the clam buckets toward one another, to rotate clam bucket assembly relative to the hook, etc., from the radio remote control transmitter to the radio remote control receiver in order to control operation of the clam bucket assembly. The clam bucket assembly can be hydraulically actuated, by a radio remote control, so to rotate and steer the clam bucket assembly.

A still further object of the present invention is to provide the clam bucket assembly with a rotational device which permits the clam buckets to rotate or spin, with respect to the crane hoist so as to permit the orientation of the clam buckets to be manipulated during operation and assist with engagement with a desired section of bulk material to be grasped.

Yet another object of the present invention is to provide the clam bucket assembly with a camera, which communicates wirelessly with a display device, and facilitates viewing of the clam bucket assembly during operation thereof by an operator to assist with accurate manipulation of the clam bucket assembly by the operator.

The present invention also relates to a clam bucket assembly a clam bucket assembly comprising an assembly framework comprises an upper section and a lower section; first and second clam buckets being supported by the lower section of the assembly framework, a first bucket cylinder for controlling operation of the first clam bucket to engage and discharge a desired bulk material, and a second bucket cylinder for controlling operation of the second clam bucket to engage and discharge a desired bulk material; and the clam bucket assembly supporting its own independent power module for supplying hydraulic power to at least the first and the second bucket cylinders and controlling operation of the first and the second clam buckets, and the power module being supported by the upper section of the assembly framework, and the clam bucket assembly being completely powered solely by the power module supported by the bucket assembly.

The present invention also relates to a method of forming an self-powered clam bucket assembly, the method comprising: forming an assembly framework from an upper section and a lower section; supporting first and second clam buckets by the lower section of the assembly framework, providing a first bucket cylinder for controlling operation of the first clam bucket to engage and discharge a desired bulk material, and providing a second bucket cylinder for controlling operation of the second clam bucket to engage and discharge a desired bulk material; and supporting, on the clam bucket assembly, an independent power module for supplying hydraulic power to at least the first and the second bucket cylinders for controlling operation of the first and the second clam buckets, and supporting the power module via the upper section of the assembly framework such that the clam bucket assembly being completely powered solely by the power module supported by the clam bucket assembly.

### BRIEF DESCRIPTION OF THE DRAWINGS

The accompanying drawings, which are incorporated in and constitute a part of the specification, illustrate various embodiments of the invention and together with the general description of the invention given above and the detailed description of the drawings given below, serve to explain the principles of the invention. The invention will now be described, by way of example, with reference to the accompanying drawings in which:

FIG. 1 is a diagrammatic front right side view showing a clam bucket assembly, according to the disclosure, in its closed and grasping position;

FIG. 2 is a diagrammatic front right side view showing a clam bucket assembly, according to the disclosure, in its closed and grasping position;

FIG. 3 is a diagrammatic front right side view, similar to FIG. 1, showing the clam bucket assembly in its open and discharging position; and

FIG. 4 is a diagrammatic front right side view, similar to FIG. 1, showing telescoping arrangement which facilitates adjustment of the spacing of the power module from the pair of clam bucket along with a completely enclosed and watertight power module support which facilities underwater operation of the clam bucket.

It should be understood that the drawings are not necessarily to scale and that the disclosed embodiments are sometimes illustrated diagrammatical and in partial views. In certain instances, details which are not necessary for an understanding of this disclosure or which render other details difficult to perceive may have been omitted. It should be understood, of course, that this disclosure is not limited to the particular embodiments illustrated herein.

### DETAILED DESCRIPTION OF THE PREFERRED EMBODIMENTS

The present invention will be understood by reference to the following detailed description of the disclosure, which should be read in conjunction with the appended drawings. It is to be appreciated that the following detailed description of various embodiments is by way of example only and is not meant to limit, in any way, the scope of the present invention.

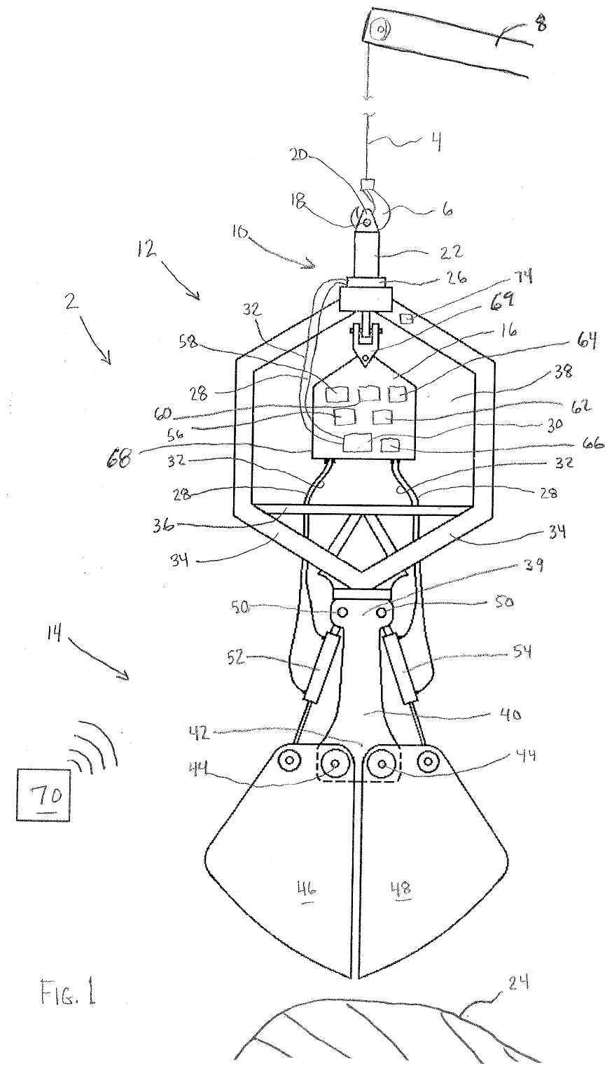

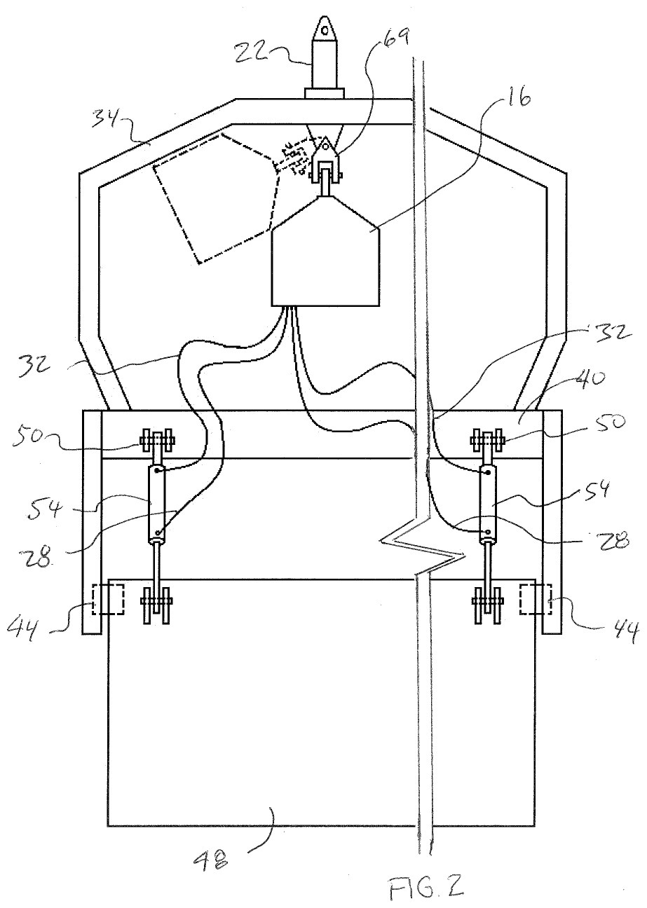

Turning first to FIGS. 1 and 2, a brief description concerning the various components of the present invention will now be briefly discussed. As can be seen in this embodiment, the present invention relates to a clam bucket assembly 2 which can be suspended, via a conventional cable 4 and a hook 6, e.g., a cable hoist, from a conventional crane or some other piece of equipment having a hydraulically actuated arm or jib 8. As there are a number of different types of heavy equipment bases, motorized forestry equipment, and other similar heavy duty vehicles that have a variety of mechanical arms, booms or jibs, the following description will refer to such equipment and mechanical arms simply as a crane or jib 8.

It is to be appreciated that a non-electrically conductive sling (not shown in detail) can be utilized between the clam bucket assembly 2 and the crane 8 such that if, for some unintended reason, the clam bucket assembly 2 inadvertently contacts or touches a power line during operation, the non-electrically conductive sling will prevent any electricity from flowing along the clam bucket assembly 2 through the non-electrically conductive sling and along the cable 4 to the crane 8 and thereby avoid possible electrocution of the operator of the clam bucket assembly 2.

The clam bucket assembly 2 has a hydraulically rotatable swivel or rotator 10 incorporated therein. The hydraulically rotatable swivel or rotator 10 is generally integrated as an upper most portion of an upper section 12 of the clam bucket assembly 2 to permit the entire clam bucket assembly 2 to rotate or pivot, as discussed below in further detail, relative to the hook 6. It is conceivable, however, that the hydraulically rotatable swivel or rotator 10 may be located between the upper section 12 and a lower section 14 of the clam bucket assembly 2. It is noted that such arrangement would permit the lower section 14 to rotate or pivot, relative to the upper section 12 of the clam bucket assembly 2, but such arrangement would normally also require a rotatable hydraulic coupling, between the power module 16 (discussed below in further detail) and the clam bucket hydraulic cylinders, in order to permit the lower section 14 of the clam bucket assembly 2 to pivot relative to the upper section 12 of the clam bucket assembly 2.

The hydraulically rotatable swivel or rotator 10 is designed to facilitate “steering” or “manipulation” of the clam bucket assembly 2, by the crane operator, during operation thereof. The upper portion 22 of the hydraulically rotatable swivel or rotator 10 comprises a rod or pin 18 which extends between a pair of side walls or plates 20 of the upper portion 12 of the hydraulically rotatable swivel or rotator 10 (see FIGS. 1 and 2), or some other conventional hanging support for the clam bucket assembly 2. As is typical in the art, the hook 6 of the crane 8 engages with the rod or pin 18 in order to suspend the clam bucket assembly 2 and thus assist with controlling vertical (e.g., up and down) as well as sideways (e.g., forward, backward, left and right) movement of the clam bucket assembly 2 relative to the ground or a pile of bulk material 24 to be grasped (only diagrammatically shown in drawings).

A lower portion 26 of the hydraulically rotatable swivel or rotator 10 is permanently connected and is integrally formed with the upper portion 12 of the assembly framework of the clam bucket assembly 2. A first rotator supply/return line 28, coupled to the hydraulic pump 30 of the power module 16, is connected to and communicates with first input of the lower portion 26 of the hydraulically rotatable swivel or rotator 10 while a second rotator supply/return line 32, coupled to the hydraulic pump 30 of the power module 16, is connected to and communicates with a second input of the lower portion 26 of a hydraulically rotatable swivel or rotator 10.

When the first rotator supply/return line 28 supplies hydraulic fluid from the power module 16 to the first input of the lower portion 26 of the hydraulically rotatable swivel or rotator 10, the lower portion 26 of the hydraulically rotatable swivel or rotator 10, as well as a remainder of the clam bucket assembly 2, rotates or turns in a first rotational direction relative to the upper portion 22 of the hydraulically rotatable swivel or rotator 10 and the hook 6. When the second rotator supply/return line 32 supplies hydraulic fluid from the power module 16 to the second input of the lower portion 26 of the hydraulic rotator 10, the lower portion 26 of the hydraulically rotatable swivel or rotator 10, as well as a remainder of the clam bucket assembly 2, rotates or turns in an opposed second rotational direction relative to the upper portion 22 of the hydraulically rotatable swivel or rotator 10 and the hook 6. Such rotation of the lower portion 26 of the hydraulically rotatable swivel or rotator 10 relative to the upper portion 22 of the hydraulically rotatable swivel or rotator 10 and the hook 6, in a desired rotational direction, permits the operator to suggest or induce desired rotation of the clam bucket assembly 2 so as to achieve a desired position or orientation of the clam bucket assembly 2 and thereby assist the clam bucket assembly 2 with engaging with a desired location of the ground or a desired section or area of a pile of bulk material (all diagrammatically shown as element 24).

The upper section 22 of the framework of the clam bucket assembly 2 typically comprises a plurality of (e.g., horizontal/cross and vertical/longitudinal) frame members 34, 36 which are interconnected with one another, in a conventional manner, to define a partially enclosed central region or compartment 38 which sized and shaped to accommodate the power module 16 therein. A plurality of vertical/longitudinal frame members 34 extend from the lower portion 26 of the hydraulically rotatable swivel or rotator 10 and are permanently connected with an upper end 39 of a bucket support member 40 with. In addition, a plurality of horizontal/cross frame members 36 interconnect the vertical/longitudinal frame members 34 with one another to define a structural framework which generally surrounds and protects the power module 16, during operation and transport thereof, while still enabling the power module 16 to swing or pivot back and forth, e.g., about 90 degrees, within the central compartment 38 during operation, as well be discussed below in further detail.

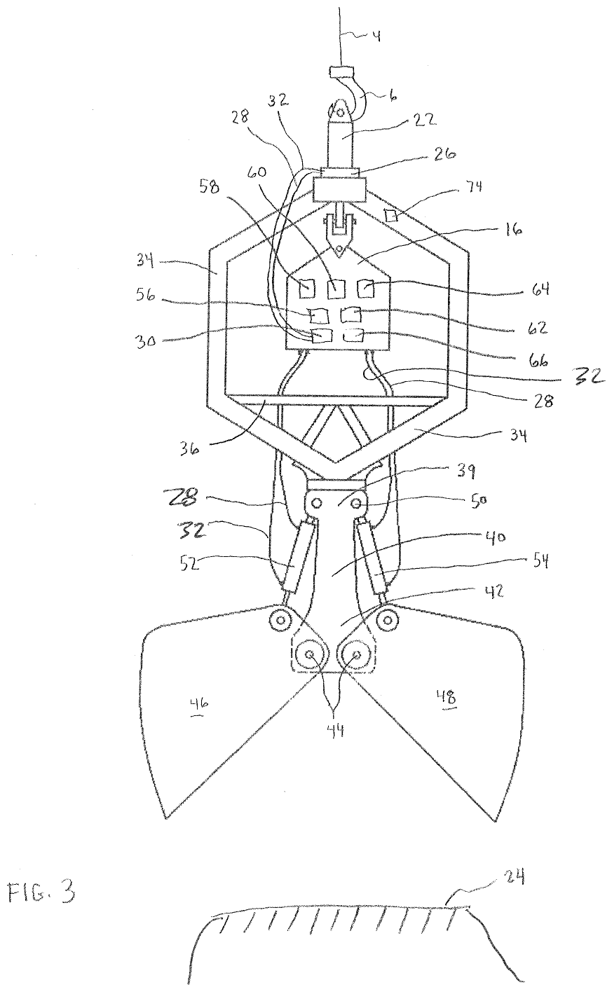

As generally shown in FIGS. 1 and 3, the vertical/longitudinal frame members 34 are bowed or curved outwardly so that the central compartment 38 defines an internal volume. All of the vertical/longitudinal and horizontal/cross frame members 34, 36 of the assembly framework are sufficiently thick, robust and durable so as to form a rugged framework which is suitable to accomplish the operation described herein in further detail.

The lower end of the upper section 12 of the assembly framework of the clam bucket assembly 2 is integrally connected with a first end of the upper end of the bucket support member 40. A lower portion 42 of the bucket support member 40 has a pair of spaced apart, but parallel extending, bucket pivots 44 which each pivotably support a respective one of the first and second clam buckets 46, 48. An upper portion of the bucket support member 40 has a pair of spaced apart, but parallel extending, cylinder pivots 50 which each pivotably support a first end of a respective bucket hydraulic cylinder 52, 54. A second opposed end of each one of the bucket cylinders 52, 54 is pivotably connected to respective one of the clam buckets 46, 48 at a location which is spaced from the bucket pivots 44.

A respective first hydraulic supply/return line 28, coupled to the hydraulic pump 30 of the power module 16, is connected to and communicates with a respective first end of one of the bucket cylinders 52, 54 while a respective second hydraulic supply/return line 32, coupled to the hydraulic pump 30 of the power module 16, is connected to and communicates with a respective second end of one of the bucket cylinders 52, 54. When a first supply of hydraulic fluid is simultaneously supplied from the hydraulic pump 30 of the power module 16 (discussed below in further detail), via the first hydraulic supply/return lines 28, to the first end of each one of the respective bucket hydraulic cylinders 52, 54, each one of the first and second clam buckets 46, 48 is simultaneously pivoted or moved generally toward and into engagement with one another to close and grasp a desired quantity of bulk material 24 via the pair of clam buckets 46, 48, as shown in FIGS. 1 and 2. When a second supply of hydraulic fluid is simultaneously supplied from the hydraulic pump 30 of the power module 16, via the second hydraulic supply/return lines 32, to the second opposite end of each one of the respective bucket hydraulic cylinders 52, 54, each one of the clam buckets 46, 48 is simultaneously moved generally away from another to open and discharge the contents grasped and contained by the pair of clam buckets 46, 48, as shown in FIG. 3.

The power module 16 comprises a power plant 56 such as either a combustion (gas or diesel) engine or an electric motor 58 or combination thereof (e.g., a 1 to 300 hp motor and more preferably between 5 and 30 hp, for example). In addition, the power module 16 also includes the hydraulic pump 30 which is driven by the power plant 56 in order to generate a supply of hydraulic fluid, a hydraulic oil reservoir 60 associated with the hydraulic pump 30, at least one directional valve 62 (only diagrammatically shown) for controlling the flow of the hydraulic fluid from the hydraulic pump 30 to the various hydraulic components of the clam bucket assembly 2, a fuel/power supply 64, e.g., a (gas or diesel) fuel tank for powering either the (gas or diesel) engine, or a battery or batteries for powering the electric motor, and a radio control unit 66 which receives radio control signals from the operator for controlling operation of the clam bucket assembly 2.

All of these components of the power module 16 (power module components), for example the power plant 56, the hydraulic pump 30 and oil reservoir 60, the directional valve 62, the fuel/power supply 64, and control unit 66, etc., are only diagrammatically shown in the figures and are mounted on and supported by a pivotable power module support 68. Preferably, as shown, a pivot member 69, which supports the power module support 68, has first and second spaced apart pivots (not separately labeled) which are arranged 90 degrees with respect to one another. The first and second pivots together permit the power module support 68 to move or pivot, in any direction, while still maintaining the power module 30 in a substantially vertical orientation. As a result of this arrangement, the power module 30 always remains in a generally vertical orientation during operation of the clam bucket assembly 2 regardless of the position and/or tilt angle of the clam bucket assembly 2 as well as during transport thereof from one site to another site.

Since the entire power module 16 is supported directly by the pivotable power module support 68, the clam bucket assembly 2 is to be considered as being “self powered”. That is to say, in other words, that no additional power is transferred from the crane 8 or along an arm, boom or jig of the crane 8 to the clam bucket assembly 2 in order to facilitate operation thereof. As such no power lines, hydraulic lines, electrical cables or the like need be connected between the clam bucket assembly 2 and the crane 8, for example.

The clam bucket assembly 2 includes a radio remote control receiver which is part of or can be connected to the control unit 66 of the power module 16 and which communicates wirelessly, via radio signals, with a radio control transmitter 70 (only diagrammatically shown) typically located within an operator cabin at the base of a crane 8. The operator is able to send desired commands, e.g., to pivot the pair of buckets away from one another, to pivot the pair of buckets toward one another, etc., from the radio control transmitter 70 to the radio remote control receiver in order to control operation of the clam bucket assembly 2.

According to one embodiment, the clam bucket assembly 2 supports a camera 74 to facilitate remote viewing of the clam bucket assembly 2 by an operator to assist with precise and accurate engagement of the pair of buckets 46, 48 with the desired area of the bulk material 24 to be grasped. The camera 74 is typically supported by a conventional bracket on one of the vertical/longitudinal and horizontal/cross frame members 34, 36 of the assembly framework and typically faces vertically downward in the direction of the pair of buckets 46, 48. A mating display device is located within the crane 8 or other piece of equipment and receives at least a wireless video signal from the camera to facilitate viewing of the clam bucket assembly 2 by the operator. The camera 74 and the display device communicate wirelessly with one another, as is conventional and well known in the art. For some applications, the camera is a conventional water-tight submersible camera to facilitate viewing under water or in extremely wet environmental conditions.

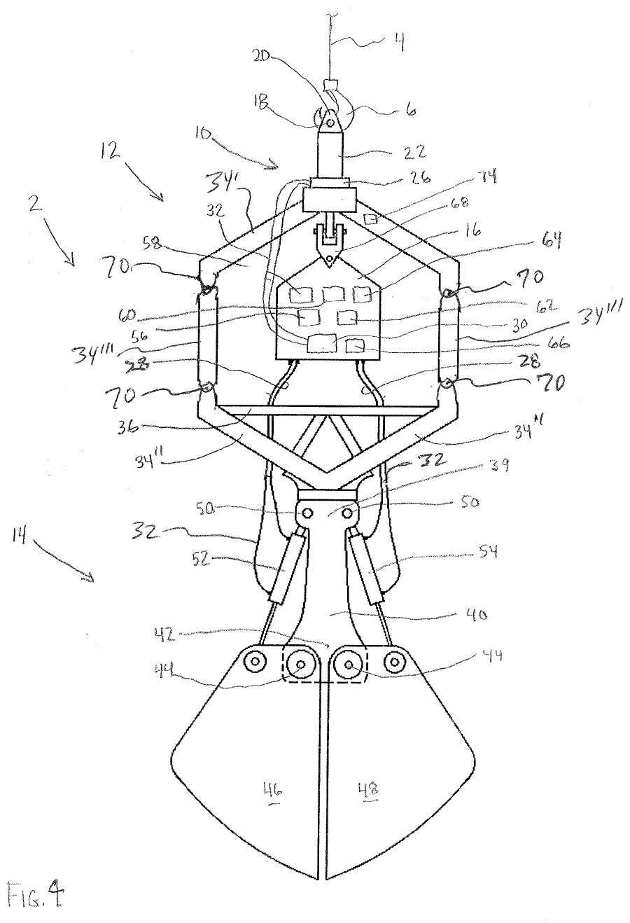

Turning now to FIG. 4, a further embodiment of the present disclosure will now be described. As this embodiment is very similar to the previously discussed embodiment, only the differences between this new embodiment and the previous embodiment will be discussed in detail while identical elements will be given identical reference numerals.

A first difference between this embodiment and the previous embodiments is that the length of the vertical/longitudinal frame members 34 is adjustable so as to increase/decrease the distance or spacing between the power module 16 and the upper end 39 of the bucket support member 40. As generally shown in this Figure, the vertical/longitudinal frame members 34 comprise an adjustable length section that includes first and second frame members 34′, 34″ and an intermediate frame member 34′″. An upper end of the first frame member 34′ is permanently connected to the hydraulically rotatable swivel or rotator 10 while a lower end of the second frame member 34″ is permanently connected to the bucket support member 40. A through bore, for example, of an upper end of the second frame member 34″ mates with a mating through bore of a lower end of the first frame member 34′. The first and the second frame members 34′, 34″ are normally fastened to one another by a respective releasable fastener 72 (only diagrammatically shown) so as to prevent any undesired movement of the first and the second frame members 34′, 34″ relative to one another during operation.

It is to be appreciated that the overall axial length of the first and the second frame members 34′, 34″ can be readily altered by the operator, depending upon the particular application. For example, if it is desirable for the first and the second frame members 34′, 34″ to have a longer total axial length, e.g., the upper end 39 of the bucket support member 40 is to be spaced further away from the power module 16, then the respective first and second hydraulic supply/return lines 28, coupled to the hydraulic pump 30 of the power module 16, are first disconnected from the clam bucket assembly 2 and according replace with a suitably length set of longer first and second hydraulic supply/return lines 28.

Next, the first and the second frame members 34′, 34″ are disconnected from one another by removing each one of the releasable fasteners 72. Then, a first end of a respective intermediate frame member 34′″, have a desired length of between 2 and 40 feet, for example, is connected to the lower end of each one of the first frame member 34′ by a respective releasable fastener 72. Thereafter, an opposite second end of each one of the respective intermediate frame members 34′″, have a desired length of between 2 and 40 feet for example, is connected to the upper end of each respective second frame member 34″ by a respective releasable fastener 72. Follow assembly, the intermediate frame member 34′″ facilitate increasing the overall total length of the adjustable length section to space the bucket support member 40 a desired distance further away from the power module 16.

A second difference between this embodiment and the previous embodiments is that the power module support 68, which supports the components of the power module 16 (power module components), for example, the power plant 56, the hydraulic pump 30 and oil reservoir 60, the directional valve 62, the fuel/power supply 64, and control unit 66, etc., comprises a completely and totally enclosed watertight enclosure. The power plant 56, which is typically utilized in such a watertight enclosure, is an electrical motor and associated battery power supply so that combustion air and exhaust gases do not present any issues. Such watertight enclosure facilitates submersing the power module 16 underwater so that the clam bucket assembly 2 can still operate and grasp a desired bulk material, object, item, tree, etc. and remove the same for a water environment.

A third difference between this embodiment and the previous embodiments is that the camera is an underwater camera which facilitates viewing of operation of the clam bucket assembly 2 underwater by the operator.

As convention in the art, a jib may be attached to the upper end of a crane 8, for example, to provide additional reach over a structure, a power line, etc.

Operation of the Clam Bucket Assembly

When transport of a desire bulk material 24 is desired, the operator remotely activates the hydraulic pump 30 to supply hydraulic fluid simultaneously to a desired end of the bucket hydraulic cylinders 52, 54. The operator then utilizes the camera 74 to operate the crane 8 and manipulate and guide the clam bucket assembly 2 into engagement with the desire bulk material 24 to be conveyed. It is to be noted that the operator may rotate the hydraulically rotatable swivel or rotator 10, relative to the hook 6, in order to induce alignment of the clam buckets 46, 48 with the desire bulk material 24 to be conveyed.

Once the clam buckets 46, 48 are located slightly above and closely adjacent the desire bulk material 24 to be grasped and conveyed, hydraulic fluid is then supplied from the hydraulic pump 30 to the first end of the bucket hydraulic cylinders 52, 54 to actuate the clam buckets 46, 48 and simultaneously close both of the clam buckets 46, 48 and thereby grasp the desire bulk material 24 to be conveyed. As the clam buckets 46, 48 pivot or move toward one another, the desire bulk material 24 to be conveyed is thus grasped and clamped by the pair of clam buckets 46, 48, as shown in FIG. 3.

Next, the operator will then typically operate the crane 8, or other piece of equipment, to move the clam bucket assembly 2 and the grasped bulk material 24 to a desired discharge location. Once the clam bucket assembly 2 and the grasped bulk material 24 to be conveyed are moved to a desired location, then the operator can commence lowering the clam bucket assembly 2. Next, the operator operates the crane 8, or other piece of equipment, to lower the clam bucket assembly 2 and the supported desire bulk material 24 to be conveyed toward the ground, other surface, container, vehicle, pile, etc.

Once the conveyed desire bulk material 24 to be conveyed is sufficiently close to the ground, container, some other surface, etc., the operator can then remotely actuate the hydraulic pump 30 of the power module 16 to supply hydraulic fluid to the bucket cylinders 52, 54 to actuate the clam buckets 46, 48 and simultaneously open and release the supported desire bulk material 24 to be conveyed onto the ground or some other surface, as shown in FIG. 3. Thereafter, the operator raises the clam bucket assembly 2 and can then reposition the clam bucket assembly 2 back again to grasp and convey another load of the desire bulk material 24 to be conveyed. The above process is repeated numerous times as required or desired by the operator.

While various embodiments of the present invention have been described in detail, it is apparent that various modifications and alterations of those embodiments will occur to and be readily apparent to those skilled in the art. However, it is to be expressly understood that such modifications and alterations are within the scope and spirit of the present invention, as set forth in the appended claims. Further, the invention(s) described herein is capable of other embodiments and of being practiced or of being carried out in various other related ways. In addition, it is to be understood that the phraseology and terminology used herein is for the purpose of description and should not be regarded as limiting. The use of “including,” “comprising,” or “having,” and variations thereof herein, is meant to encompass the items listed thereafter and equivalents thereof as well as additional items while only the terms “consisting of” and “consisting only of” are to be construed in a limitative sense.

The foregoing description of the embodiments of the present disclosure has been presented for the purposes of illustration and description. It is not intended to be exhaustive or to limit the present disclosure to the precise form disclosed. Many modifications and variations are possible in light of this disclosure. It is intended that the scope of the present disclosure be limited not by this detailed description, but rather by the claims appended hereto.

A number of implementations have been described. Nevertheless, it will be understood that various modifications may be made without departing from the scope of the disclosure. Although operations are depicted in the drawings in a particular order, this should not be understood as requiring that such operations be performed in the particular order shown or in sequential order, or that all illustrated operations be performed, to achieve desirable results.

Wherefore, I/we claim:

1. A clam bucket assembly comprising:
an assembly framework comprises an upper section and a lower section;
first and second clam buckets being supported by the lower section of the assembly framework, a first bucket cylinder for controlling operation of the first clam bucket to engage and discharge a desired bulk material, and a second bucket cylinder for controlling operation of the second clam bucket to engage and discharge a desired bulk material; and
the clam bucket assembly supporting its own independent power module for supplying hydraulic power to at least the first and the second bucket cylinders and controlling operation of the first and the second clam buckets, and the power module being supported by the upper section of the assembly framework, and the clam bucket assembly being completely powered solely by the power module supported by the bucket assembly.

2. The clam bucket assembly according to claim 1, wherein a pivotable power module support is connected to the upper section of the assembly framework and the pivotable power module support supports the power module.

3. The clam bucket assembly according to claim 2, wherein the pivotable power module support is pivotably connected to the upper section of the assembly framework so that the power module support always maintains the power module in a generally vertical orientation during operation and during transport of the clam bucket assembly.

4. The clam bucket assembly according to claim 1, wherein the power module comprises either a combustion engine, an electric motor, or a combination thereof;
a hydraulic pump which is driven by either the combustion engine, the electric motor or the combination thereof to generate a supply of hydraulic fluid,
a hydraulic oil reservoir coupled to the hydraulic pump, and
either a fuel, an electrical power supply or a combination thereof is provided for powering either the combustion engine, the electric motor or the combination thereof.

5. The clam bucket assembly according to claim 2, wherein the clam bucket assembly supports a camera which facilitates remote viewing of the clam bucket assembly by an operator to assist with precise and accurate engagement of the pair of buckets with the desired bulk material to be grasped.

6. The clam bucket assembly according to claim 1, wherein an upper most portion of the upper section of the clam bucket assembly comprises a hydraulically rotatable swivel or rotator which permits the clam bucket assembly rotate or pivot relative to the hook and a wire cable of the crane and facilitate manipulation of the clam bucket assembly by a crane operator.

7. The clam bucket assembly according to claim 6, wherein an upper portion of the hydraulically rotatable swivel or rotator comprises a rod or pin which facilitates hanging of the clam bucket assembly from a hook, and a lower portion of the hydraulically rotatable swivel or rotator is permanently connected and is integral formed with the upper section of the assembly framework of the clam bucket assembly.

8. The clam bucket assembly according to claim 7, wherein a first rotator supply/return line, coupled to the hydraulic pump, is connected to and communicates with the lower portion of the hydraulically rotatable swivel or rotator while a second rotator supply/return line, coupled to the hydraulic pump, is connected to and communicates with the lower portion of the hydraulically rotatable swivel or rotator.

9. The clam bucket assembly according to claim 8, wherein when the first rotator supply/return line supplies hydraulic fluid to the lower portion of the hydraulically rotatable swivel or rotator, the lower portion rotates in a first rotational direction relative to the upper portion of the hydraulically rotatable swivel or rotator and the hook, while when the second rotator supply/return line supplies hydraulic fluid to the lower portion of the hydraulic rotator, the lower portion of the hydraulically rotatable swivel or rotator, as well as a remainder of the clam bucket assembly, rotates in an opposite second rotational direction relative to the upper portion of the hydraulically rotatable swivel or rotator and the hook.

10. The clam bucket assembly according to claim 4, the power module has a radio remote control receiver which is connected to a control unit of the power module which communicates with a radio control transmitter located remotely from the clam bucket assembly, and the radio remote control receiver receives radio control signals and the control unit actuates either the combustion engine, the electric motor or the combination thereof and the hydraulic pump to generate the supply of hydraulic fluid to the bucket cylinders.

11. The clam bucket assembly according to claim 1, the upper section of the clam bucket assembly comprises a plurality of frame members which are interconnected with one another to define a partially enclosed central region or compartment which sized and shaped to accommodate the power module therein.

12. The clam bucket assembly according to claim 11, wherein vertical/longitudinal frame members are bowed or curved outwardly such that the central compartment surrounds and protects the power module, during operation and transport thereof, while still enabling the power module to swing or pivot back and forth within the central region or compartment during operation and transport.

13. The clam bucket assembly according to claim 10, wherein a lower end of the upper section of the assembly framework of the clam bucket assembly is integrally connected with a first upper end of a bucket support member, a lower portion of the bucket support member has a pair of spaced apart, but parallel extending, bucket pivots which each pivotably support a respective one of the first and second clam buckets,
an upper portion of the bucket support member has a pair of spaced apart, but parallel extending, cylinder pivots which each pivotably support a first end of a respective bucket hydraulic cylinder, and
a second opposed end of each one of the bucket cylinders is pivotably connected to respective one of the clam buckets at a location which is spaced from the bucket pivots.

14. The clam bucket assembly according to claim 10, wherein a respective first hydraulic supply/return line, coupled to the hydraulic pump, is connected to and communicates with a respective first end of one of the bucket cylinders while a respective second hydraulic supply/return line, coupled to the hydraulic pump, is connected to and communicates with a respective second end of one of the bucket cylinders,
when a first supply of hydraulic fluid is simultaneously supplied from the hydraulic pump, via the first hydraulic supply/return lines, to the first end of each one of the respective bucket hydraulic cylinders, each one of the first and second clam buckets is simultaneously pivoted or moved generally toward and into engagement with one another to close and grasp a desired quantity of bulk material via the pair of clam buckets, and
when a second supply of hydraulic fluid is simultaneously supplied from the hydraulic pump, via the second hydraulic supply/return lines, to the second opposed end of each one of the respective bucket hydraulic cylinders, each one of the clam buckets is simultaneously moved generally away from another to open and discharge bulk material grasped and contained by the pair of clam buckets.

15. The clam bucket assembly according to claim 10, wherein a power module support is pivotably suspended from the upper section of the assembly framework of the clam bucket assembly by a power module pivot pin so that the power module components can swing or sway, relative to the upper section of the framework, and thus always remain in a generally vertical orientation during operation of the clam bucket assembly regardless of the position and/or tilt angle of the clam bucket assembly as well as during transport thereof from one site to another site.

16. The clam bucket assembly according to claim 11, wherein a length of the plurality of frame members is adjustable so as to alter a distance or spacing between the power module and an upper end of the bucket support member.

17. The clam bucket assembly according to claim 16, wherein the plurality of frame members comprise a plurality of first and the second frame members which are connected to one another by at least one releasable fastener, when it is desired to alter the distance or spacing between the power module and the upper end of the bucket support member, the first and the second frame members are disconnected from one another and a respective intermediate frame member is interconnected therebetween so as to increase the distance or spacing between the power module and the upper end of the bucket support member.

18. The clam bucket assembly according to claim 1, wherein the pivotable power module support comprises a watertight enclosure which is pivotably connected to the upper section of the assembly framework and encloses a completely electric power module so that the power module is submersible in water.

19. The clam bucket assembly according to claim 1, wherein the clam bucket assembly is equipped with a watertight camera which facilitates viewing of operation of the clam bucket assembly under water.

20. A method of forming an self-powered clam bucket assembly, the method comprising:
forming an assembly framework from an upper section and a lower section;
supporting first and second clam buckets by the lower section of the assembly framework, providing a first bucket cylinder for controlling operation of the first clam bucket to engage and discharge a desired bulk material, and providing a second bucket cylinder for controlling operation of the second clam bucket to engage and discharge a desired bulk material; and
supporting, on the clam bucket assembly, an independent power module for supplying hydraulic power to at least the first and the second bucket cylinders for controlling operation of the first and the second clam buckets, and supporting the power module via the upper section of the assembly framework such that the clam bucket assembly being completely powered solely by the power module supported by the clam bucket assembly.
